(19) United States
(12) Patent Application Publication
(10) Pub. No.: US 2008/0273087 A1
(43) Pub. Date: Nov. 6, 2008

(54) Method for gathering and storing surveillance information

(75) Inventors: Jan Otto Blom, Espoo (FI); Rosalinde Belzer, Helsinki (FI); Wendy March, Portland, OR (US); Nana Yaw O'Boaitey, Orlando, FL (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/797,333

(22) Filed: May 2, 2007

(51) Int. Cl. H04N 7/18

(52) U.S. Cl. 348/143; 348/E07.085

(57) ABSTRACT

The invention relates to a method where an event involving at least one object is detected. The bearing of an electronic device is determined. The electronic device is positioned to obtain its position. The identity of a user of the electronic device is determined. A number of sensor devices are located based on the bearing and the position to obtain a set of target sensors. A first sensor recording is obtained from a first sensor device among the set of target sensors. The first sensor recording is associated with the identity of the user.

### BACKGROUND OF THE INVENTION

1. Field of the Invention

The invention relates to surveillance systems. Particularly, the invention relates to a method for the gathering and storing surveillance information.

2. Description of the Related Art

The reduced component and storage device prices have made it possible to deliver vast numbers of digital cameras. Many of these are used for surveillance purposes. The density of recording surveillance cameras has also increased vastly. Many of these cameras are connected to the Internet and can be controlled remotely.

However, despite the proliferation of surveillance cameras, it is still very difficult to coordinate the gathering of recorded material from surveillance cameras located within an area related to a crime or other incident that requires later investigation. Several surveillance system operators have to be contacted in order to obtain the surveillance data. This often requires a visit in person to the site of surveillance system operator, which in turn requires a lot of manpower. The amount of material that has to be sifted through is often also formidable. The problem is made worse by the fact that the recordings may have varying timings and clock settings. This boils down to the fact that in the case of petty crimes or incidents it is not possible to utilize surveillance data from a multitude of sources. A further nuisance is that the possibility of tampering with the surveillance data has to be taken seriously in many cases. A further problem is that current surveillance systems do not provide the possibility for explicit record retaining requests or the depositing of annotations for future access. The annotations would be helpful in the obtaining of material relating to a given incident.

### SUMMARY OF THE INVENTION

The invention relates to a method comprising: receiving an indication of an event; recording a bearing of an electronic device upon receiving the indication; positioning the electronic device to obtain a position upon receiving the indication; locating at least one sensor device based on the bearing and the position to obtain a set of target sensors; obtaining a first sensor recording from a first sensor device among the set of target sensors; and associating the first sensor recording with identity information obtained from the electronic device. The invention relates also to a system comprising: an electronic device configured to receive an indication of an event, to record a bearing of the electronic device upon receiving the indication and to communicate with a network node; the network node configured to obtain a position of the electronic device, to obtain identity information from the electronic device, to locate at least one sensor device based on the bearing and the position to form a set of target sensors, to obtain a first sensor recording from a first sensor device among the set of target sensors and to associate the first sensor recording with the identity information; and the first sensor device configured to record the first sensor recording and to provide the first sensor recording to the network node. The invention relates also to an electronic device, comprising: a user interface entity configured to allow a user to indicate an event; at least one bearing sensor configured to record a bearing of the electronic device upon detecting the indication; positioning entity configured to position the electronic device to obtain a position upon detecting the indication; and a communication entity configured to provide the bearing, the position and identity information to a network server. The invention relates also to an electronic device, comprising: means for allowing a user to indicate an event; at least one bearing sensor means for recording a bearing of the electronic device upon detecting the indication; means for positioning the electronic device to obtain a position upon receiving the indication; and means for providing the bearing, the position and the identity of the user to a network server.

The invention relates also to a network node, comprising: a communication entity configured to obtain a position and a bearing of an electronic device, to obtain an identity information of the electronic device; a locating entity configured to locate at least one sensor device based on the bearing and the position to form a set of target sensors; and a storage entity configured to obtain a first sensor recording from a first sensor device among the set of target sensors and to associate the first sensor recording with the identity information.

The invention relates also to a network node, comprising: means for obtaining a position and a bearing of an electronic device; means for obtaining an identity information of the electronic device; means for locating at least one sensor device based on the bearing and the position to form a set of target sensors; means for obtaining a first sensor recording from a first sensor device among the set of target sensors; and means for associating the first sensor recording with the identity information.

The invention relates also to a computer program embodied on a computer readable medium, the computer program comprising code for controlling a processor to execute a method comprising: obtaining a position and a bearing of an electronic device; obtaining an identity information of the electronic device; locating at least one sensor device based on the bearing and the position to form a set of target sensors; obtaining a first sensor recording from a first sensor device among the set of target sensors; and associating the first sensor recording with the identity information.

The invention relates also to a computer program embodied on a computer readable medium, the computer program comprising code for controlling a processor to execute a method comprising: receiving an indication of an event via a user interface of an electronic device; reading a bearing of the electronic device from a bearing sensor upon receiving the indication; determining a position of the electronic device upon receiving the indication; and providing the bearing, the position and identity information to a network server.

The invention relates also to a computer program comprising code for controlling a processor to execute a method comprising: obtaining a position and a bearing of an electronic device; obtaining an identity information of the electronic device; locating at least one sensor device based on the bearing and the position to form a set of target sensors; obtaining a first sensor recording from a first sensor device among the set of target sensors; and associating the first sensor recording with the identity information.

The invention relates also to a computer program comprising code for controlling a processor to execute a method comprising: receiving an indication of an event via a user interface of an electronic device; reading a bearing of the electronic device from a bearing sensor upon receiving the indication; determining a position of the electronic device upon receiving the indication; and providing the bearing, the position and identity information to a network server. In one embodiment of the invention, the bearing of an electronic device is the direction to which a camera within the electronic device points. In one embodiment of the invention, the bearing of an electronic device is the direction perpendicular to the display surface of the electronic device. In one embodiment of the invention, the bearing of an electronic device an arbitrary direction made known to the user of the electronic device. In one embodiment of the invention, the bearing of an electronic device is the direction pointed to with an external pointer device communicating with the electronic device.

In one embodiment of the invention, the storage entity within the network node is configured to sign digitally the first sensor recording and a metadata record to obtain a security token, the metadata record comprising at least one of: the identity of the user, time and an identity of the first sensor device.

In one embodiment of the invention, the communication entity in the network node is configured to send the security token to an information system of an authority. The authority may be, for example, the police.

In one embodiment of the invention, the locating entity within the network node is configured to determine a target range from the position and the bearing, to inspect sensor information associated with the first sensor device to determine whether the position of the first sensor device belongs to the target range and to select the first sensor device to the set of target sensors. The locating entity may obtain the sensor information from at least one external server, wherein the sensor information may be stored, for example, in a resource description framework format.

In one embodiment of the invention, the locating entity within the network node is configured to determine at least one route from the position and the bearing, to inspect sensor information associated with the first sensor device to determine whether the first sensor device is associated with the at least one route and to select the first sensor device to the set of target sensors. The information on the routes may be stored in at least one external server in the form of a logical mesh, wherein nodes and edges are defined. The sensor devices may be associated with identified edges, which represent routes. The logical mesh may be defined, for example, using the extensible markup language. The locating entity may obtain the sensor information from at least one external server, wherein the sensor information may be stored, for example, in a resource description framework format.

In one embodiment of the invention, the first sensor device is configured to obtain the bearing and the position, to recognize a moving object in the first sensor device based on the bearing and the position, to track the movement of the moving object, to determine the trajectory of the moving object, to determine a second sensor device based on the trajectory; the second sensor device configured to receive an information request from the network node and to provide a second sensor recording to the network node; and the locating entity within the network node is configured to add the second sensor device to the set of target sensors. The storage entity within the network node is configured to obtaining the second sensor recording from the second sensor. In one embodiment of the invention, the locating entity within the electronic device is configured to recording a recognition bearing. A recognition bearing means a bearing that is used in a sensor device to aid in recognizing at least one object from the range of the sensor device. The communication entity within the electronic device sends the recognition bearing to the network node. The communication entity within a network node, that is, a security server, sends the recognition bearing and the position to the first sensor device. The first sensor device locates the object with the recognition bearing and the position within the range of the first sensor device. After the recognition bearing, a tracking bearing is recorded by the locating entity within the electronic device. The communication entity within the electronic device sends the tracking bearing to the network node. The network node locates at least one second sensor device based on the tracking bearing and the position to obtain a second set of target sensors to which a tracking request is sent.

In one embodiment of the invention, the area of sensor devices used to track the object is enlarged at specified time periods. Upon enlarging the area, the old area is no longer used to track the object. Several sensor devices within a given area may be used to monitor the object or a nearby range simultaneously.

In one embodiment of the invention, a positioning entity within the electronic device configured to obtaining the position of the electronic device from a satellite positioning system.

In one embodiment of the invention, a positioning entity within the electronic device is configured to obtain the position of the electronic device with a mobile communication system positioning method.

In one embodiment of the invention, a positioning entity within the electronic device is configured to obtain the position with at least one of Observed Time Difference Of Arrival, Enhanced Observed Time Difference and cell identification. The actual positioning may be performed in a server within the mobile communication network that the electronic device communicates with.

In one embodiment of the invention, the first sensor device comprises a camera. In one embodiment of the invention, the first sensor device comprises a video camera, for example, a digital video camera. In one embodiment of the invention, the sensor device comprises at least one of a thermometer, a luminance sensor, a wind gauge and an air pressure sensor.

In one embodiment of the invention, the electronic device comprises a mobile communication device.

In one embodiment of the invention, the electronic device comprises a mobile station within a mobile communication network.

In one embodiment of the invention, the communication system comprises a packet switched network, for example, an Internet Protocol (IP) network. A network address may be an IP address.

In one embodiment of the invention, said communication system comprises a mobile communication network. In one embodiment of the invention, said mobile terminal comprises a mobile station. In one embodiment of the invention, the communication system comprises at least one of a Global System of Mobile Communications (GSM) network and a Universal Mobile Telephone System (UMTS) network. The mobile terminal may be, for example, a GSM mobile station or a UMTS mobile station with a dual mode or multimode functionality to support different access types.

In one embodiment of the invention, the computer program is stored on a computer readable medium. The computer readable medium may be a removable memory card, magnetic disk, optical disk or magnetic tape.

The embodiments of the invention described hereinbefore may be used in any combination with each other. Several of the embodiments may be combined together to form a further embodiment of the invention. A method, a communication system, a network node, an electronic device or a computer program to which the invention is related may comprise at least one of the embodiments of the invention described hereinbefore.

The benefits of the invention are related to improved efficiency in the obtaining of surveillance information.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a diagram illustrating a city block to which a surveillance system according to an embodiment of the invention is installed;

FIG. 2 is a block diagram illustrating a surveillance system in one embodiment of the invention;

FIG. 3 is a flow chart illustrating a method for the capture of surveillance information in one embodiment of the invention;

FIG. 4 is a map illustrating a city block which has a surveillance system utilizing tracking trajectory in one embodiment of the invention;

FIG. 5 is a block diagram illustrating an electronic device in one embodiment of the invention; and

FIG. 6 is a block diagram illustrating a network node in one embodiment of the invention.

### DETAILED DESCRIPTION OF THE EMBODIMENTS

Reference will now be made in detail to the embodiments of the present invention, examples of which are illustrated in the accompanying drawings.

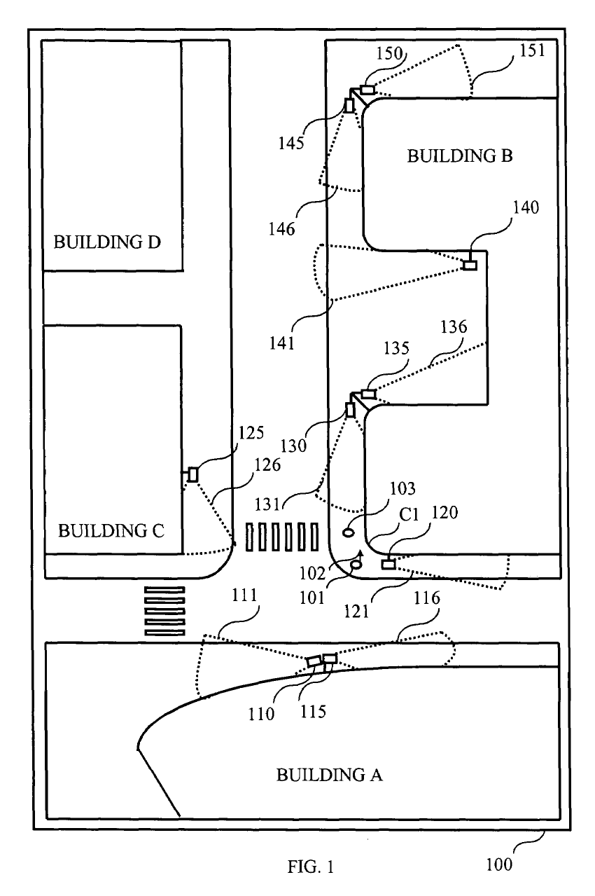

FIG. 1 is a map illustrating a city block to which a surveillance system according to an embodiment of the invention is installed. In FIG. 1 there is illustrated a city block 100. The city block comprises two streets that intersect at a corner C1. In the intersection area there are two zebra crossings. The city block comprises buildings A, B, C and D. There are two surveillance cameras mounted to the front wall of building A, namely surveillance cameras 110 and 115. The visual ranges of surveillance cameras 110 and 115 are illustrated with dashed areas 111 and 116, respectively. The visual range of a surveillance camera is limited by the bearing of the camera. The visual range might also be limited by the resolution of the camera, zoom ratio of the camera, lighting conditions and distance to a target, but usually surveillance cameras are pointed slightly downwards from their position on a wall. Thus, the bearing of a surveillance camera is the most important limiting factor for the visual range. There is a surveillance camera 125 mounted to the wall of the building C. The visual range of surveillance camera 125 is illustrated with dashed area 126. Building B has six surveillance cameras mounted to its walls. There is a surveillance camera 120 with a visual range 121 to cover the flank of the building at corner C1. There are also surveillance cameras 130 and 135 mounted to another corner of building B with visual ranges 131 and 136, respectively. There is also a surveillance camera 140 with a visual range 141 to cover a single wall. There are also two surveillance cameras namely a surveillance camera 145 and a surveillance camera 150, which cover yet another corner of building B. The visual ranges of the surveillance cameras are a visual range 146 and a visual range 151, respectively. In FIG. 1 it is assumed that the placing of the surveillance cameras is by no means intended to be optimal for the purposes of the invention disclosed herein. The placing stems from the needs of prior art closed-circuit television surveillance systems. It is assumed for example that the surveillance cameras mounted to building B are only covering certain most vulnerable parts of the building such as the main entrances and store windows.

In FIG. 1 there are also illustrated two persons: a person 101 and a person 103. Person 101 has a mobile station with her. The mobile station is illustrated with an arrow 102. For a better understanding the invention a scenario is described in the following. Let us assume that person 101 is a cashier carrying a till with day's cash from a nearby cafeteria in building A to a bank. Unfortunately, person 103 suddenly appears and snatches a bag containing the till and starts running away along the flank of building B onwards from corner C1. In order to initiate the method and system disclosed herein, person 101 points her mobile station 102 towards the direction to which person 103 is running and gives a command to mobile device 102 to start the tracing. It may be assumed that as person 103 is moving away the escape route might traverse one of the visibility areas illustrated in FIG. 1.

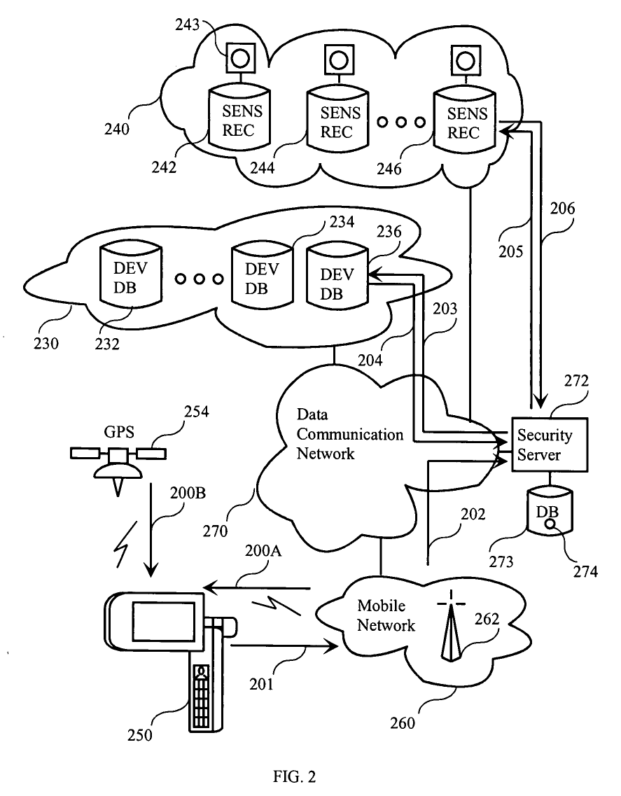

FIG. 2 is a block diagram illustrating a surveillance system in one embodiment of the invention. In FIG. 2 there is a mobile station 250. Mobile station 250 communicates with a base station 262 within a mobile network 260. Base station 262 may also be an access point or an access node. Mobile network 260 may be any wireless network such as a Wireless Local Area Network (WLAN). Mobile station 250 also receives signals from a number of positioning satellites such as satellite 254. Satellite 254 may be, for example, a Global Positioning System (GPS) satellite. Mobile network 260 provides IP connectivity access to a data communication network 270. To data communication network 270 there is connected a security server 272. Security server 272 has a mass memory device 273, which is used to store a security token 274 to be formed using surveillance information gathered and information associated with the user of mobile station 250.

Connected to network 270 there is also a device database server cluster 230. Cluster 230 comprises an arbitrary number of device database servers such as, for example, device database servers 232, 234 and 236. Servers in cluster 230 store a wide range of information regarding a number of sensor devices available for the purposes of the method and system of the invention. For a given sensor device there is stored, for example, the type of the device, the capabilities of the device, the location of the device in terms of geographical coordinates in two or three dimensions, one or more monitoring sectors, and the identity of the device. The identity of the device may be, for example, an IP address of the device or a Fully Qualified Domain Name (FQDN) of the device or generally a logical name associated with the device. A device may also be identified using a Uniform Resource Locator (URL). Sensor device information in cluster 230, may be, expressed using for example the Resource Description Framework (RDF) defined by W3 consortium. Cluster 230 may also store information regarding the spatial relationships of the sensor devices. In cluster 230 there may be stored data structures pertaining to roads and buildings and the intersections connecting the roads. In the device information for a given device, there may be specified the road, the street, the walkway or the passage that the device supervises. Thus, it is possible to traverse the device database using various candidate routes which may represent an escape path for a person or a vehicle and to gather the list of sensor device on the candidate routes.

Connected to network 270 there is a sensor network 240. Sensor network 240 comprises an arbitrary number on sensor devices such as sensor device 243. Associated with each sensor device there is sensor record memory. In FIG. 2 there are shown three sensor record memories namely memories 242, 244 and 246. Each of these memories has associated with it a sensor device that feed information to the memory. Sensor devices may comprise, for example, surveillance cameras, movement detectors, infrared cameras and elevator scales, which measure the weights of persons carried in elevators.

The starting point in FIG. 2 is that the owner of mobile station 250 is a victim or witness to a crime. It should also be noted that instead of a crime it may be question of any event which requires the tracking one or more persons, vehicles, animals or other objects like buildings or part of buildings. The one or more objects may be in motion or in place. The tracking of a target, for example, a person or a vehicle must be first initiated by the user of mobile station 250. The tracing is initiated by pointing mobile station 250 towards the observed or assumed direction of escape of the target and giving the tracking command to mobile station 250. The tracking command is given by pressing a key, by clicking a pointer device or by uttering a voice command. The result of the tracking command is that mobile station 250 registers its current bearing using a number of accelerometers or other bearing detectors such as an electronic compass. Mobile station 250 also obtains its position either directly, using a satellite positioning system, or via a positioning method offered by mobile network 260. A mere cell identity may be used in the cases where more precise position information is not available. Mobile station 250 sends its bearing and its position to security server 272 via mobile network 260, as illustrated with arrows 201 and 202. The identity of mobile station 250 and/or the identity of the user of mobile station 250 are also provided to security server 272. The identity of the mobile station may be, for example, a Mobile Subscriber ISDN Number (MSISDN). The identity of the user of mobile station 250 may be, for example, a Mobile Subscriber ISDN Number (MSISDN), a public or a private user identity, a Session Initiation Protocol (SIP) logical name, an electronic mail address or any logical name. Upon receiving the tracking request illustrated with arrow 202, security server 272 extracts the mobile station 250 identity or the identity of the user of mobile station 250, the device bearing and the position information. Security server 272 may also determine a monitoring duration relevant to the conditions under which the tracking must be performed. The user of mobile station 250 may also have specified in the tracking request the type of object to be tracked, that is, whether it is question of a person, a vehicle, an animal or a stationary object such as a building or a canal. Based on the target object type the duration of the tracking may be determined in security server 272. Security server 272 determines the set of relevant sensors. The basis for determining the set of relevant sensors is the position and the bearing of mobile station 250, as provided in the tracking request 202.

In one embodiment of the invention, the security server enquires cluster 230 to obtain the identities of the sensor devices that fall to a specified range from the position of mobile station 250. The bearing information may be used to narrow the range only to a specified sector, for example, to 180 degrees, that is, a half circle the center of which is the position of mobile station 250. The narrowed range, that is, a sector is determined using a trajectory, for example, the bearing based on the pointing direction and location on the mobile station.

In one embodiment of the invention, security server first determines the position of mobile station 250 on a network of routes the information of which is stored by device database servers in cluster 230. The routes may be specified separately for those that are accessible to a walker and those that are accessible to a motor vehicle. The routes accessible to a person comprise overpasses, lifts and elevators, tunnels and underpasses, whereas routes accessible to a motor vehicle include ramps, roads, streets and highways. Security server 272 determines the current position of mobile station 250 in the network of routes. The network may be expressed in terms of a mesh comprising nodes that are connected by edges. The nodes represent intersections of route segments and edges represent route segments, that is, stretches of roads or walkways that are located between intersections. For each sensor it is assumed that there is information on the edge, to which the visual range of the sensor device is pointing. As the current node or edge corresponding to the position of mobile station 250 and the bearing of mobile station is determined, a transitive closure is computed of the network up to a predefined range from the starting point. The computation of the transitive closure involves the traversal of the network using, for example, the well known Floyd-Warshall algorithm. The traversal of the network of routes may involve several different query and response messages to a device database server within cluster 230. Such a query and response is illustrated with arrows 203 and 204 in FIG. 2. The result of the finished traversal is a list of sensor device identities as in the previous embodiment.

The set of relevant sensor devices is used by security server 272 to obtain sensor recording information from sensor network 240. The logical names for the relevant sensor devices may be translated into addresses for sensor record memories. Security server 272 sends an information request to each relevant sensor record memory. In one embodiment of the invention, a part of the logical name for a sensor device, for example, a path name is added to the information request. In response to the information requests the sensor record memories provides the recordings back to security server 272. The requesting of sensor information from sensor record memory 246 is illustrated with arrow 205. The response comprising the sensor recordings is illustrated with arrow 206. In response to the obtaining of all sensor recording information security server 272 associates the sensor recordings with information associated with mobile station 250 and/or the user of mobile station 250 and the tracking request. The associated sensor recordings and mobile station information and the tracking information are also referred to as a security token. In one embodiment of the invention the sensor record memories provide digital signatures for the sensor information so that the sensor information maybe data origin authenticated later on by a receiving authority.

In one embodiment of the invention the initiator of the tracking request, that is, the user of mobile station 250 may take a picture or a video of the target for the trace using a camera in mobile station 250. The picture information is then provided to security server 272 and from there to relevant sensors to assist in capturing scenes of visual information containing matching visual objects. In one embodiment of the invention a sensor device, upon receiving target object visual information, may adjust its zoom to focus to all objects that match with the target object visual characteristics.

In one embodiment of the invention, security server 272 uses network topology information associated with the possible routes for the target to determine when a given sensor device should start recording information and when a given sensor device should abandon the recording of information. In this way it is possible to spare data storage capacity and to reduce the amount of data recorded pertaining to a given event. Thus it is also easier for authorities to go through the captured material in order to solve the incident.

In one embodiment of the invention, security server 272 sends a first information request to at least one sensor device closest to the position and the bearing of mobile station 250. The closest sensor device may be, for example, sensor device 243. Sensor device 243 is configured to obtain the bearing and the position. Sensor device 243 recognizes a moving object based on the bearing and the position. Additionally, the security server 272 or sensor device 243 may receive additional information from the mobile station about the one or more objects to be recognized. Alternatively, the security server 272 or sensor device 243 may send a request for additional information to the mobile station about the one or more objects to be recognized. Sensor device 243 tracks the movement of the moving object and determines the trajectory of the moving object. Thereupon sensor device 243 determines a second sensor device based on the trajectory. Sensor device 243 indicates an information request to the second sensor device either directly or via security server 272. The second sensor device is configured to receive the information request and to provide a second sensor recording to security server 272 which stores the sensor recording. Similarly, the second sensor device may determine a third sensor device and so on.

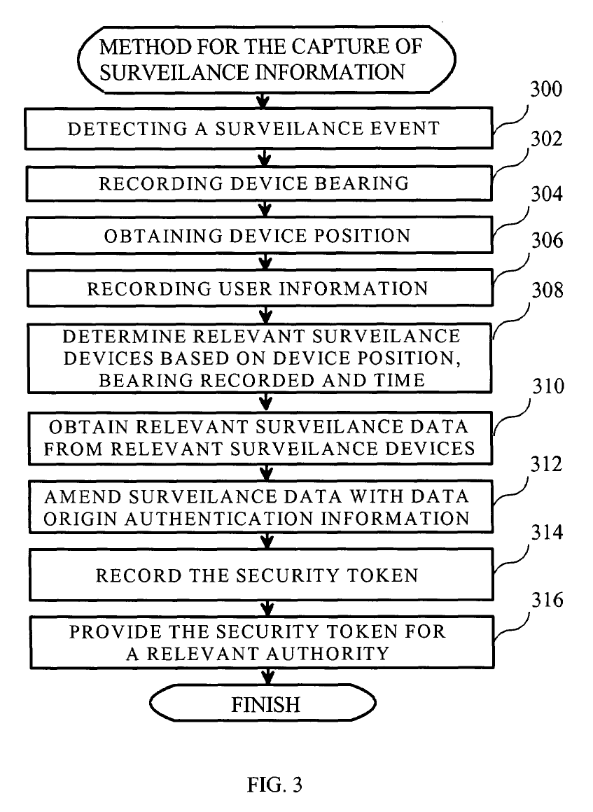

FIG. 3 is a flow chart illustrating a method for the capture of surveillance information in one embodiment of the invention.

At step 300, an event requiring surveillance tracking is detected. Such an event is any event which involves the monitoring of a moving or a still target object. The event may be a crime in which case the target is the criminal. Alternatively, the event may be a fire in which case the target is the fire or an object afire.

In one embodiment of the invention the event is detected by a user of an electronic device, for example, a mobile station. The event is indicated to the electronic device. A type of the event may also be indicated to the electronic device via a user interface of the electronic device. The type may indicate, for example, whether it is question of a person or a vehicle that is to be tracked.

At step 302, the bearing of the electronic device is recorded. By the bearing may be meant, for example, the recording or photographing direction of the camera, the direction of an antenna or the direction of the line spanned by the keyboard and loudspeaker. In one embodiment of the invention, the bearing is determined using at least on accelerometer. In one embodiment of the invention the bearing of the electronic device is determined using an electronic compass.

At step 304, the position of the electronic device is determined.

In one embodiment of the invention, the position of the electronic device is determined using a satellite positioning system. In one embodiment of the invention, the position of the mobile station is determined using a triangulation method involving at least two base stations of a mobile communication system. In one embodiment of the invention, the positioning is performed with the identity of the cell currently used by the mobile station.

At step 306, information on the user of the electronic device is recorded. In one embodiment of the invention, the information recorded comprises, for example, a user identity, a mobile subscriber identity or a mobile station identity.

At step 308, the relevant surveillance devices and sensor devices are determined based on the position of the electronic device, the bearing recorded and current time. In one embodiment of the invention, the determination uses an external database to which surveillance and sensor device position and identity information is stored. In one embodiment of the invention, surveillance device address information is obtained using the surveillance device identity information. In one embodiment of the invention, the relevant surveillance devices are determined based on the distance to the mobile station. In one embodiment of the invention, the determination uses a route topology database wherein surveillance devices are associated with given route segments.

At step 310, relevant surveillance data is obtained from the relevant surveillance devices. In one embodiment of the invention, sensor data is also obtained from pure sensor type of devices.

At step 312, the surveillance data may be amended with data origin authentication information. The data origin authentication information may also be furnished to the surveillance data by the relevant surveillance devices.

At step 314, a security token comprising the surveillance data and user information and device position and bearing information is formed and stored.

At step 316, the security token is provided to a relevant authority, if this is requested by the user. The user may be provided with option to enter further information concerning the event.

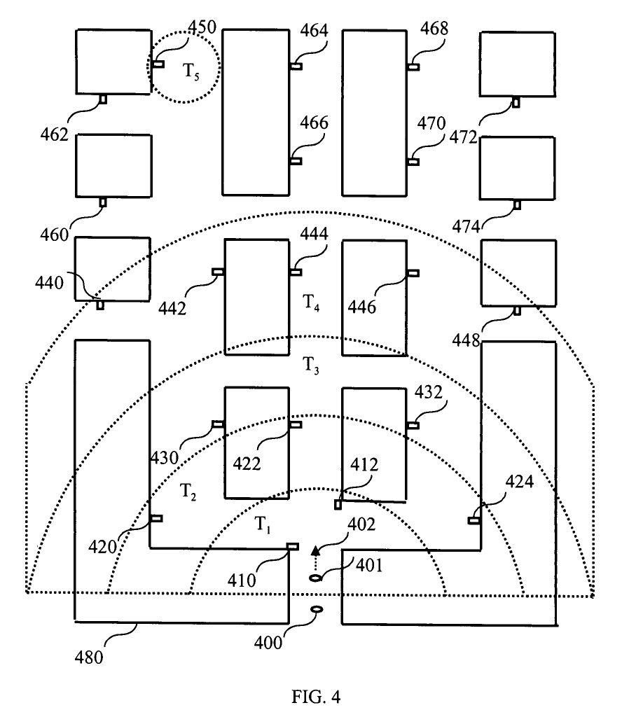

FIG. 4 is a map illustrating a city block which has a surveillance system utilizing tracking trajectory in one embodiment of the invention. In FIG. 4 there are a number of buildings or other similar structures that block passage such as building 480. To the walls of the buildings are installed a number of surveillance cameras such as cameras 410, 412, 420, 422, 424, 430, 432, 442, 444, 446 and 448. There is also a camera 450. There are also cameras 460, 462, 464, 466, 468, 470, 472 and 474.

The starting point in FIG. 4 is that a crime or another event that requires the tracking of a person 401 occurs. In response to the event a second person 400 wishes to start the tracking. The movement, that is, the direction of escape of person 401 is illustrated with arrow 402. Person 400 has an electronic device (not shown). Person 400 points the electronic device towards person 401 and presses a key to initiate the marking and the tracking of person 401 for the surveillance system. Any other command issued via the user interface within electronic device may substitute pressing of the key. The electronic device records the bearing of the electronic device and obtains the position of the electronic device. The electronic device sends a tracking request to a security server (not shown) such as security server 272 in FIG. 2. The tracking request comprises the bearing and the position of the electronic device. The security server determines the nearest surveillance cameras taking into consideration the position and the bearing indicated by the electronic device. This comprises that the security server determines a sector based on the bearing. The angle of the sector may be set to a predefined value such as 180 degrees or the angle may be determined based on knowledge pertaining to routes leading away in a direction corresponding to the bearing. The knowledge may be determined using an external server or memory comprising route topology information. The security server determines a default time schedule for enlarging the sector radius. A time schedule specifies a set of time intervals at which the radius is increased. At the increasing of the radius the previous sector falling within the enlarged sector may be abandoned. Thus, initially sector T₁ is determined as the tracking sector. The security server determines the surveillance cameras within sector T₁. The determination may use an external server or memory from which the surveillance camera identities are obtained in response to an indication of the area of sector T₁. The area may be indicated, for example, with a set of coordinates marking the boundaries of sector T₁. In sector T₁ there are cameras 410 and 412. The security server sends a tracking request to cameras 410 and 412. The tracking request comprises the position of person 400 and the bearing recorded. The tracking request may also comprise a timer for marking duration of the tracking. An initial tracking request from the security server may also comprise the bearing and the position recorded by the electronic device. The bearing and the position area used by cameras 410 and 412 to calculate a target area within the visual range of cameras 410 and 412. If a single object within the target area is observed, at least one of cameras 410 and 412 may be focused to the target area. It should be noted that person 401 may only be observed in either camera 410 or 412. It may also be possible that there is no single recognizable object with the target area. Both camera 410 and camera 412 record video data for dispatch to the security server. At the expiry of the timer or when a camera within sector T₁ observes that person 401 leaves the visual range of the camera, the camera returns the recordings to the security server. Upon returning the recordings, the recording process may be ended in the cameras that provided the recordings. The recordings may also comprise information on the direction to which the person moved. The recordings may also be provided as a constant video stream to the security server. In response to the obtaining of the recordings, the security server checks if it obtained a direction from at least one of cameras 410 and 412. In one embodiment of the invention, security server may also have obtained a new bearing from the electronic device of person 400 while waiting for video recordings from cameras 410 and 412. Person 400 may point the electronic device a second time and press a key to determine the new bearing, which is not necessarily used to point person 401, but rather to indicate the direction of movement of person 401.

Thus, in one embodiment of the invention, the user of the electronic device may himself give two different trajectories, namely a first trajectory for object recognition and a second for movement direction of the object. The second trajectory helps monitoring and following a moving object, and a third trajectory may be determined based on these two trajectories given by the user.

The new bearing or direction information from either camera 410 or 412 may be used to rotate or otherwise adjust the tracking sector or any other tracking area.

Upon receiving the recordings from cameras 410 and 412, the security server associates the camera recordings with information associated with the electronic device and/or the user of the electronic device and information on the tracking request. The associated camera recordings and electronic device information and the tracking information are also referred to as a security token. The security token may be amended at later phases of the tracking as the sector is enlarged and camera recordings are obtained from further cameras.

In response to the obtaining of recordings from cameras 410 and 412, the security server enlarges the sector radius. The next sector radius in FIG. 4 is T₂. The security server determines that cameras 420, 422 and 424 fall within the area of sector T₂. The security server sends a tracking request to cameras 420, 422 and 424. One of the cameras may obtain a specific indication on an object which represents person 401. The indication may comprise the anticipated point of entry to the visual range of the camera and visual recognition characteristics on the moving object. Thereupon, cameras 420, 422 and 424 start recording video data. At the expiry of the time interval for sector area T₂ or at an indication of object exit from visual range, cameras 420, 422 and 424 return their video recordings to the security server. The security token is amended with the video recording data obtained. At the next tracking step cameras 430 and 432 perform the recording. Thereupon, cameras 442, 444, 446 and 448 perform the recording.

Visual recognition characteristics on the moving object may also be provided to other cameras such as camera 450 that are located outside the areas where the sector is enlarged to obtain continuous recordings from the cameras. It should be noted, however, that a camera within a sector may be movement activated. At a later time T₅ camera 450 recognizes the moving object based on the visual recognition characteristics and records until person 401 exists the visual range of camera 450 or when a timer expires. Camera 450 provides the recordings to the security server and an indication of the identity of camera 450. The security token is amended with the new information.

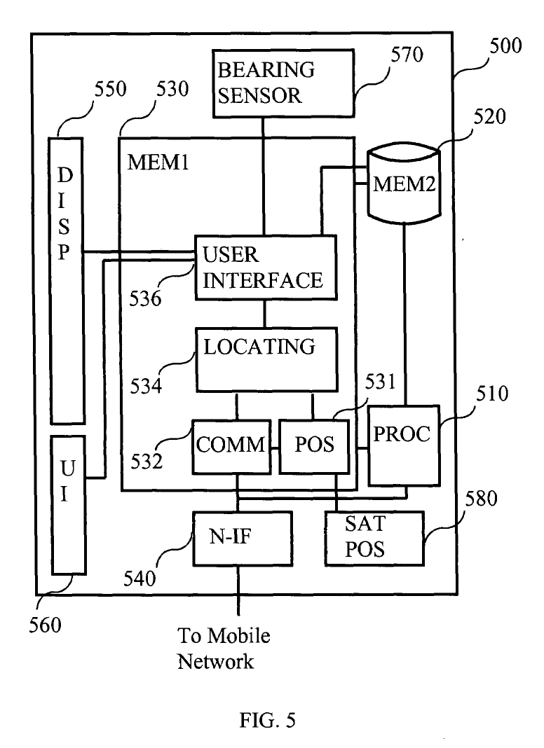

FIG. 5 is a block diagram illustrating an electronic device in one embodiment of the invention. The electronic device may be a mobile station such as mobile station 250 illustrated in FIG. 2. The mobile station maybe a mobile telephone, a personal digital assistant (PDA), a pager, a digital camera or camcorder, a position detection device, or any combination of the aforementioned. In FIG. 5 there is an electronic device 500. Electronic device 500 comprises a processor 510 and a secondary memory 520. The secondary memory may be, for example, a hard disk or a flash memory or an optic disk. Electronic device 500 comprises also a primary memory 530. When processor 510 executes functionalities associated with the invention primary memory 530 comprises, for example, a user interface entity 536, a locating entity 534, a communication entity 532 and a positioning entity 531. Electronic device also comprises one or more network interface units such as network interface unit 540, a display unit 550, a user interface unit 560, at least one bearing sensor 570 and a satellite positioning unit 580. The user interface unit may comprise, for example, a keypad, a keyboard and a pointer device. Communication entity 532 comprises the communication functions, for example, Internet Protocol functions. Network interface 540 may be, a radio interface comprising, for example, a Wireless Local Area Network (WLAN) interface, a Bluetooth interface, a Wimax interface, a UWB (ultra wide band), low power radio frequency interface and a radio interface for a mobile telecommunication network.

In one embodiment of the invention, communication entity 532 is comprised in the operating system of electronic device 500. The entities within electronic device 500 in FIG. 5, such as user interface entity 536, locating entity 534 and communication entity 532 may be implemented in a variety of ways. They may be implemented as processes executed under the native operating system of the network node. The entities may be implemented as separate processes or threads or so that a number of different entities are implemented by means of one process or thread. A process or a thread may be the instance of a program block comprising a number of routines, that is, for example, procedures and functions. The entities may be implemented as separate computer programs or as a single computer program comprising several routines or functions implementing the entities. The program blocks are stored on at least one computer readable medium such as, for example, a memory circuit, memory card, magnetic or optic disk. Some entities may be implemented as program modules linked to another entity. The entities in FIG. 5 may also be stored in separate memories and executed by separate processors, which communicate, for example, via a message bus or an internal network within the network node. An example of such a message bus is the Peripheral Component Interconnect (PCI) bus.

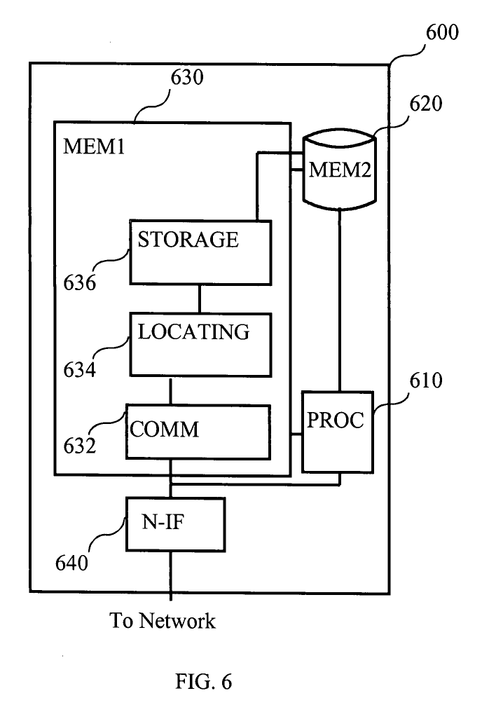

FIG. 6 is a block diagram illustrating a network node in one embodiment of the invention. The network node may be security server 272 as illustrated in FIG. 2. In FIG. 6 there is a network node 600. Network node 600 comprises a processor 610 and a secondary memory 620. The secondary memory may be, for example, a hard disk or a flash memory or an optic disk. Network node 600 comprises also a primary memory 630. When processor 610 executes functionalities associated with the invention primary memory 630 comprises, for example, a storage entity 636, a locating entity 634 and a communication entity 632. Electronic device also comprises a network interface unit 640. Communication entity 632 comprises the communication functions, for example, Internet Protocol functions. Network interface 640 may be, a radio interface comprising, for example, a Wireless Local Area Network (WLAN) interface and a radio interface for a mobile network, or a fixed network interface.

In one embodiment of the invention, communication entity 632 is comprised in the operating system of network node 600. The entities within network node 600 in FIG. 6, such as storage entity 636, locating entity 634 and communication entity 632 may be implemented in a variety of ways. They may be implemented as processes executed under the native operating system of the network node. The entities may be implemented as separate processes or threads or so that a number of different entities are implemented by means of one process or thread. A process or a thread may be the instance of a program block comprising a number of routines, that is, for example, procedures and functions. The entities may be implemented as separate computer programs or as a single computer program comprising several routines or functions implementing the entities. The program blocks are stored on at least one computer readable medium such as, for example, a memory circuit, memory card, magnetic or optic disk. Some entities may be implemented as program modules linked to another entity. The entities in FIG. 6 may also be stored in separate memories and executed by separate processors, which communicate, for example, via a message bus or an internal network within the network node. An example of such a message bus is the Peripheral Component Interconnect (PCI) bus.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (e.g., voice, modem, and the like), wireless communications media, one or more wireless communications networks, cellular communications networks, G3 communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

It is obvious to a person skilled in the art that with the advancement of technology, the basic idea of the invention may be implemented in various ways. The invention and its embodiments are thus not limited to the examples described above; instead they may vary within the scope of the claims.

1. A method comprising:
receiving an indication of an event;
recording a bearing of an electronic device upon receiving the indication;
positioning the electronic device to obtain a position upon receiving the indication;
locating at least one sensor device based on the bearing and the position to obtain a set of target sensors;
obtaining a first sensor recording from a first sensor device among the set of target sensors; and
associating the first sensor recording with identity information obtained from the electronic device.

2. The method according to claim 1, the method further comprising:
signing digitally the first sensor recording and a metadata record to obtain a security token, said meta-data record comprising at least one of the identity information, time and an identity of the first sensor device.

3. The method according to claim 1, the method further comprising:
sending the security token to an information system of an authority.

4. The method according to claim 1, wherein the locating step further comprises:
determining a target range from the position and the bearing;
inspecting sensor information associated with the first sensor device to determine whether the position of the first sensor device belongs to the target range; and
selecting the first sensor device to the set of target sensors.

5. The method according to claim 1, wherein the locating step further comprises:
determining at least one route from the position and the bearing;
inspecting sensor information associated with the first sensor device to determine whether the first sensor device is associated with the at least one route; and
selecting the first sensor device to the set of target sensors.

6. The method according to claim 1, wherein the method further comprises:
obtaining the bearing and the position to the first sensor device;
recognizing the object in the first sensor device based on the bearing and the position;
tracking the movement of the object in the first sensor;
determining the trajectory of the object in the first sensor;
determining a second sensor device based on the trajectory;
adding the second sensor device to the set of target sensors; and
obtaining a second sensor recording from the second sensor.

7. The method according to claim 1, the method further comprising:
recording a recognition bearing in the electronic device;
providing the recognition bearing and the position to the first sensor device;
locating the object with the recognition bearing and the position within the range of the first sensor device;
recording a tracking bearing in the electronic device; and
locating at least one second sensor device based on the tracking bearing and the position to obtain a second set of target sensors.

8. The method according to claim 1, wherein the positioning step further comprises:
obtaining the position of the electronic device from a satellite positioning system.

9. The method according to claim 1, wherein the positioning step further comprises:
obtaining the position of the electronic device with a mobile communication system positioning method.

10. The method according to claim 1, wherein the positioning method comprises at least one of Observed Time Difference Of Arrival, Enhanced Observed Time Difference and cell identification.

11. The method according to claim 1, wherein the first sensor is a video camera.

12. The method according to claim 1, wherein the electronic device is a mobile communication device.

13. A system, comprising:
an electronic device configured to receive an indication of an event, to record a bearing of the electronic device upon receiving the indication and to communicate with a network node;
the network node configured to obtain a position of the electronic device, to obtain identity information from the electronic device, to locate at least one sensor device based on the bearing and the position to form a set of target sensors, to obtain a first sensor recording from a first sensor device among the set of target sensors and to associate the first sensor recording with the identity information; and
the first sensor device configured to record the first sensor recording and to provide the first sensor recording to the network node.

14. The system according to claim 13, the system further comprising:
the network node configured to sign digitally the first sensor recording and a metadata record to obtain a security token, said metadata record comprising at least one of the identity of the user, time and an identity of the first sensor device.

15. The system according to claim 13, the system further comprising:
the network node configured to send the security token to an information system of an authority.

16. The system according to claim 13, the system further comprising:
the network node configured to determine a target range from the position and the bearing, to inspect sensor information associated with the first sensor device to determine whether the position of the first sensor device belongs to the target range and to select the first sensor device to the set of target sensors.

17. The system according to claim 13, the system further comprising:
the network node configured to determine at least one route from the position and the bearing, to inspect sensor information associated with the first sensor device to determine whether the first sensor device is associated with the at least one route and to select the first sensor device to the set of target sensors.

18. The system according to claim 13, the system further comprising:
the first sensor device configured to obtain the bearing and the position, to recognize a object in the first sensor device based on the bearing and the position, to track the movement of the object, to determine the trajectory of the object, to determine a second sensor device based on the trajectory;
the second sensor device configured to receive an information request from the network node and to provide a second sensor recording to the network node; and
the network node configured to add the second sensor device to the set of target sensors and to obtaining the second sensor recording from the second sensor.

19. The system according to claim 13, the system further comprising:
the electronic device configured to record a recognition bearing and to record a tracking bearing;
the network node configured to provide the recognition bearing and the position to the first sensor device and to locate at least one second sensor device based on the tracking bearing and the position to obtain a second set of target sensors; and
the first sensor device configured to locate the object with the recognition bearing and the position within the range of the first sensor device.

20. The system according to claim 13, wherein the system further comprises:
the electronic device configured to obtaining the position of the electronic device from a satellite positioning system.

21. The system according to claim 13, wherein the system further comprises:
the electronic device configured to obtain the position of the electronic device with a mobile communication system positioning method.

22. The system according to claim 21, wherein the electronic device is configured to obtain the position with at least one of Observed Time Difference Of Arrival, Enhanced Observed Time Difference and cell identification.

23. The system according to claim 13, wherein the first sensor comprises a video camera.

24. The system according to claim 13, wherein the electronic device comprises a mobile communication device.

25. An electronic device, comprising:
a user interface entity configured to allow a user to indicate an event ;
at least one bearing sensor configured to record a bearing of the electronic device upon detecting the indication;
positioning entity configured to position the electronic device to obtain a position upon detecting the indication; and
a communication entity configured to provide the bearing, the position and identity information to a network server.

26. An electronic device, comprising:
means for allowing a user to indicate an event;
at least one bearing sensor means for recording a bearing of the electronic device upon detecting the indication;
means for positioning the electronic device to obtain a position upon receiving the indication; and
means for providing the bearing, the position and the identity of the user to a network server.

27. A network node, comprising:
a communication entity configured to obtain a position and a bearing of an electronic device, to obtain an identity information from the electronic device;
a locating entity configured to locate at least one sensor device based on the bearing and the position to form a set of target sensors; and
a storage entity configured to obtain a first sensor recording from a first sensor device among the set of target sensors and to associate the first sensor recording with the identity information.

28. A network node, comprising:
means for obtaining a position and a bearing of an electronic device;
means for obtaining an identity information from the electronic device;
means for locating at least one sensor device based on the bearing and the position to form a set of target sensors;
means for obtaining a first sensor recording from a first sensor device among the set of target sensors; and
means for associating the first sensor recording with the identity information.

29. A computer program embodied on a computer readable medium, the computer program comprising code for controlling a processor to execute a method comprising:
obtaining a position and a bearing of an electronic device;
obtaining identity information of the electronic device;
locating at least one sensor device based on the bearing and the position to form a set of target sensors;
obtaining a first sensor recording from a first sensor device among the set of target sensors; and
associating the first sensor recording with the identity of the user.

30. The computer program according to claim 29, wherein said computer readable medium is a removable memory card, a holographic memory, a magnetic disk or an optical disk.

31. A computer program embodied on a computer readable medium, the computer program comprising code for controlling a processor to execute a method comprising:
receiving an indication of an event via a user interface of an electronic device;
reading a bearing of the electronic device from a bearing sensor upon receiving the indication;
determining a position of the electronic device upon receiving the indication; and
providing the bearing, the position and identity information to a network server.

32. The computer program according to claim 31, wherein said computer readable medium is a removable memory card, a holographic memory, a magnetic disk or an optical disk.
